(19) United States
(12) Patent Application Publication
(10) Pub. No.: US 2004/0094990 A1
(43) Pub. Date: May 20, 2004

(54) Power window device fitted on the lock of the motor vehicle door

(76) Inventor: Melchor D. Castellon, Barcelona (ES)

Correspondence Address: DICKSTEIN SHAPIRO MORIN & OSHINSKY LLP, 41st Floor, 1177 Avenue of the Americas, New York, NY, 10036-2714, US

(21) Appl. No.: 10/689,611

(22) Filed: Oct. 22, 2003

(30) Foreign Application Priority Data
Nov. 14, 2002 (ES) 200202611/4

(51) Int. Cl. B60J 1/08

(52) U.S. Cl. 296/146.2

(57) ABSTRACT

It comprises guiding and sliding means for the window pane and driving means for the window pane mounted in the motor vehicle lock which include an electric motor and a gearmotor assembly acting on a single driving cable. These guiding and sliding means for the window pane comprise respective rails positively mounted on opposed edges of the inner panel of the motor vehicle door. Only two pulleys are mounted for a driving cable, which are positively fixed to the inner panel of the door through their own shaft.

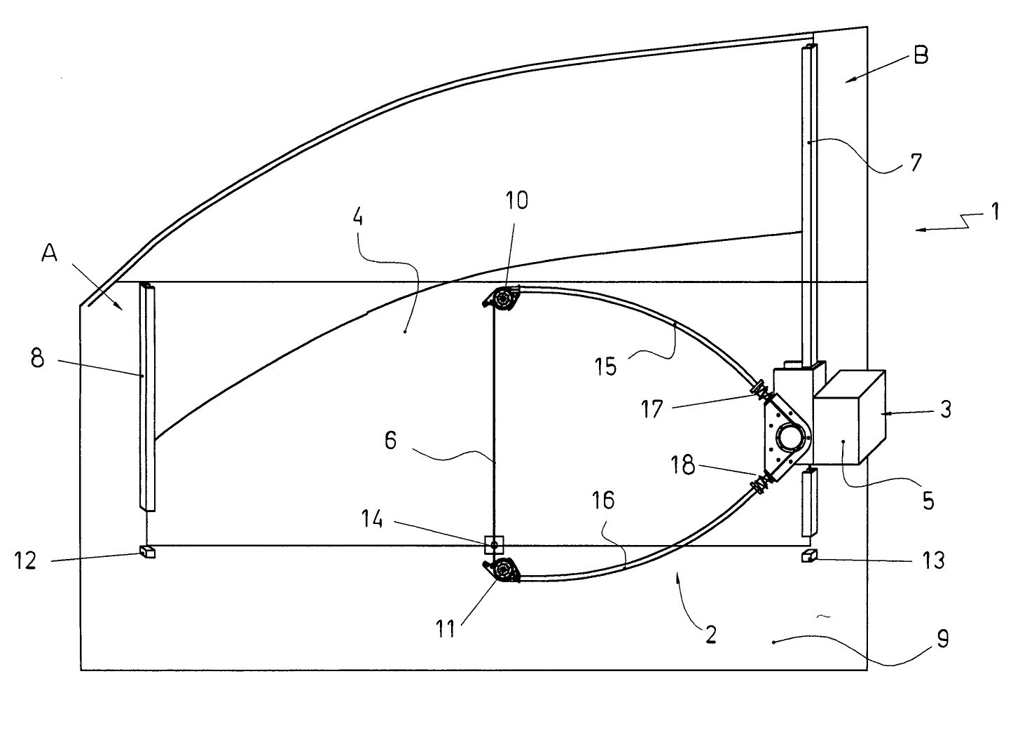

The assembly is greatly simplified since the conventional rail is removed and the number of pulleys is reduced. Friction and noise are reduced in use.

The present patent application relates, as stated in its title, to an “IMPROVED POWER WINDOW DEVICE FITTED ON THE LOCK OF THE MOTOR VEHICLE DOOR” which novel manufacturing, conformation and design features fulfil the purpose to which it has been specifically conceived, with a maximum safety and effectiveness.

The invention is applied to a specific type of power window devices in motor vehicles adapted to be mounted directly on the gearmotor assembly in the lock of the door. A power window device of this type is described in the Spanish Patent Application P200202217 filed in the name of the same applicant. Said power window device essentially comprises a first guiding and sliding assembly fitted into the doorframe of the motor vehicle door and a second guiding and sliding assembly provided in the rail of the power window device, said assemblies being provided with sliding members fixed to the window pane. There are also included driving means for said guiding and sliding assemblies and the whole assembly is mounted, as stated before, in the motor vehicle lock with the rail secured thereto.

In this patent the variables of the design in said power window assembly were set forth and they were depending on various parameters as the distance between points of contact of the sliding member in the rail; the distance from the upper edge of the window pane to the fastening edge of the sliding member; the distance from an end of the rail to the points of contact; the height from the lower portion of the motor vehicle door to the belt line; the window height, etc.

By determining the relationship between the previous variables it was allowed to overcome the drawback of the conventional power window devices secured to the motor vehicle lock arisen from instability of the assembly in use. This instability was produced since fastening of the window pane in the sliding member and guiding thereof had certain looseness which negatively influenced on the system operation, which were amplified by the action of the large cantilever of the window pane (the power window device is mounted in the lock, in a side end of the door).

Once said variables were defined in the main patent, it has been found that the appropriate and more advantageous structural configuration is the one herein described according to the present invention.

The present invention provides a new improved power window device fitted on the lock of the motor vehicle door having an extremely simple construction and a very effective operation as it achieves a high dynamic stability.

The power window device of the invention essentially comprises guiding and sliding means and driving means for the motor vehicle window pane which, as it has been previously stated, are mounted in the lock of the motor vehicle. Said driving means of the window pane include an electric motor and a gearmotor assembly acting on a driving cable.

The main feature of the invention is that said guiding and sliding means for the window pane comprises respective rails positively mounted on opposed edges of the inner panel of the motor vehicle door. This configuration allows to remove the rail in the conventional power window devices thus simplifying the assembly.

Preferably, the power window device of the invention only includes two pulleys for a single driving cable. This feature involves a further simplification of the power window device of the present invention with regard to the double-rail power window devices of the prior art which use four pulleys. The use of two pulleys is due to the fact that only a single driving cable is present. In addition, according to the invention, said two pulleys are positively fixed to the inner panel of the door through their own shaft.

Many advantages are achieved and they are associated to a large extent with a drastic cost reduction. The extreme mechanical simplification of the assembly by reducing the number of parts in the power window device allows to reduce the final cost thereof. Further, with said smaller number of parts, it is also possible to reduce friction produced in operation and consequently noise is also reduced. On the other hand, the assembly of the power window device that is herein described is considerably simpler and quicker than that of the known power window devices.

These advantages and features of the power window device of the present invention which have been previously set out will be clearer from the detailed description of a preferred embodiment thereof which will be given hereinafter by way of a non limitative example, with reference to the drawing that is herein enclosed, wherein a side elevational view of a motor vehicle door provided with a preferred embodiment of a power window device according to the invention is shown.

A detailed list of the various parts cited in the present patent application is given below::

(1) motor vehicle door;

(2) power window device;

(3) lock;

(4) window pane;

(5) window pane driving means;

(6) driving cable;

(7) rail;

(8) rail;

(9) inner panel of the door;

(10) pulley;

(11) pulley;

(12) end of travel lower stop;

(13) end of travel lower stop;

(14) window pane support;

(15) driving cable sheath;

(16) driving cable sheath;

(17) spring;

(18) spring;

(A, B) door pillars.

In the FIGURE which is herein enclosed, the door of a motor vehicle is shown indicated at (1) which is provided with an improved power window device (2) mounted in the lock (3) thereof according to the invention.

The power window device (2) comprises guiding and sliding means for the window pane (4) of the door (1) and driving means (5) for said window pane (4) which are mounted in said lock (3). These driving means (5) for the window pane (4) include an electric motor and a gearmotor assembly (not shown) acting on a driving cable (6).

Said guiding and sliding means for the window pane (4) comprises respective U-shaped cross-section rails (7, 8) through which said window pane (4) is allowed to slide. These rails (7, 8) are positively mounted in opposed edges of the inner panel (9) of the motor vehicle door (1), that is to say, in the pillar (A) and in the pillar (B) of the door, respectively. The driving cable (6) is a single cable and it is only wound in its travel around two pulleys (10, 11) which are positively attached to the inner panel (9) of the door (1) through their own shaft. In said panel (9) of the door (1), the corresponding end of travel inner stops (12, 13) are fixed.

As it can be seen, the driving cable (6) also includes a support (14) secured to the window pane (4) so that the movement of said driving cable (6) in either direction causes the rising or lowering action of the window pane (4) by actuating said driving means (5) mounted in the lock (3).

The upper and lower sections of the driving cable (6) are placed within respective sheaths (15, 16) thus ensuring tightening thereof by means of springs (17, 18). The assembly of the power window device (2) may be greatly facilitated by releasing the cable (6) by any appropriate means which allows prestressing said springs (17, 18) during assembly. Once the assembly is assembled, the operator removes said means acting on the said springs so that they will be expanded back tightening the cable (6).

Once having been sufficiently described what the improved power window device fitted on the lock of the motor vehicle door of the present patent application consists in accordance to the enclosed drawings, it is understood that any detail modification can be introduced as appropriate, provided that variations may alter the essence of the invention as summarised in the appended claims.

1 -“IMPROVED POWER WINDOW DEVICE FITTED ON THE LOCK OF THE MOTOR VEHICLE DOOR” said power window device (2) comprising guiding and sliding means for the motor vehicle window pane (4) and driving means (5) for said window pane mounted in the motor vehicle lock (3) which include an electric motor and a gearmotor assembly acting on a driving cable (6), characterized in that said guiding and sliding means for the window pane comprise respective rails (7, 8) positively mounted on opposed edges (A, B) of the inner panel (9) of the motor vehicle door (1).

2 -“IMPROVED POWER WINDOW DEVICE FITTED ON THE LOCK OF THE MOTOR VEHICLE DOOR” according to claim 1, characterized in that it is provided only with two pulleys (10, 11) for a single driving cable (6).

3 -“IMPROVED POWER WINDOW DEVICE FITTED ON THE LOCK OF THE MOTOR VEHICLE DOOR” according to claim 2, characterized in that said pulleys (10, 11) are positively mounted fixed to the inner panel (9) of the door (1) through their own shaft.
